(19) United States
(12) Patent Application Publication
(10) Pub. No.: US 2026/0284787 A1
(43) Pub. Date: Sep. 24, 2026

(54) LASER PROCESSING APPARATUS

(71) Applicant: Musashi WIRED Co., Ltd., Niigata (JP)

(72) Inventors: Naohiko SOMA, Niigata (JP); Ryo SATO, Niigata (JP); Hiroki SASAZAKI, Niigata (JP)

(73) Assignee: Musashi WIRED Co., Ltd., Niigata (JP)

(21) Appl. No.: 19/318,745

(22) Filed: Sep. 4, 2025

(30) Foreign Application Priority Data
Mar. 19, 2025 (JP) 2025-045645

(51) Int. Cl. B23K 26/16; B23K 26/08; B23K 26/382; B23K 101/16

(52) U.S. Cl. CPC B23K 26/16; B23K 26/0823; B23K 26/382; B23K 2101/16

(57) ABSTRACT

To provide a laser processing apparatus which reliably prevents clogging of through holes in a thin film and dirt on the thin film likely to occur due to adhesion of processing dust on the thin film during laser processing and creates numerous fine through holes in the thin film with a high precision and at a high speed. A laser processing apparatus 100 comprising: a laser processing apparatus main body 110 configured to radiate pulsed laser light LP from inside of a cylindrical body 111 through a slit-shaped gap region of the cylindrical body 111 onto a long, thin film TF, while the thin film TF is wound obliquely around the cylindrical body 111 provided with the gap region 111b having a shape of a circular arc along a circumferential surface 111a and is transferred in a longitudinal direction of the thin film TF, and continuously create numerous through holes TH in this thin film TF; and a dust collector 120 provided adjacent to the cylindrical body 111 of this laser processing apparatus main body 110 and configured to suck in and remove processing dust FM generated from laser processing.

### TECHNICAL FIELD

The present invention relates to a laser processing apparatus configured to continuously create numerous through holes in a matrix shape in a long, thin film, and particularly to a laser processing apparatus for collecting processing dust generated in this laser processing apparatus and creating numerous fine through holes in the thin film with a high precision and at a high speed.

### BACKGROUND ART

Conventionally known is a laser processing apparatus main body comprising: a cylindrical body having an opening on a circumferential surface around which a thin film to be processed is wound obliquely; a thin film transfer means for transferring the thin film wound around the cylindrical body in a longitudinal direction of the thin film; a motor having a rotation axis arranged coaxially with a central axis of the cylindrical body; a reflecting member fixed to a rotation axis shaft of the motor; and a laser light emission means for emitting pulsed laser light, in which the laser processing apparatus main body is configured to continuously create through holes in the thin film (see Patent Literature 1).

### PRIOR ART DOCUMENT

### Patent Literature

[Patent Literature 1] JP2019-42799A

### SUMMARY OF INVENTION

### Problem to be Solved by Invention

However, the laser processing apparatus main body described in Patent Document 1 generates processing dust, such as fumes, from laser processing when laser punching foil used as an electrode member in the electrochemical field is manufactured using metal foil as a material.

Therefore, there is such a problem that such processing dust must be removed as much as possible in order to improve a processing accuracy of a thin film by laser processing.

Thus, the present invention is to solve the problem of conventional technologies as described above, in other words, to provide a laser processing apparatus which reliably prevents clogging of through holes in a thin film and dirt on the thin film likely to occur due to adhesion of processing dust on the thin film during laser processing and creates numerous fine through holes in the thin film with a high precision and at a high speed.

### Solution to Problem

The invention according to claim 1 is to solve the above problem by a laser processing apparatus comprising: a laser processing apparatus main body configured to radiate pulsed laser light from inside of a cylindrical body through a slit-shaped gap region provided in the cylindrical body onto a long, thin film, while the thin film is wound obliquely around the cylindrical body provided with the gap region having a shape of a circular arc along a circumferential surface and is transferred in a longitudinal direction of the thin film, and continuously create numerous through holes in the thin film; and a dust collector provided adjacent to the cylindrical body of the laser processing apparatus main body and configured to suck in and remove processing dust generated from laser processing, in which the dust collector includes a suction port part disposed to face the gap region of the cylindrical body and configured to suck in the processing dust, a dust collection part arranged successively with respect to the suction port part and configured to collect the processing dust sucked in from the suction port part, and a dust collection air pump connected to an outer circumference side of the dust collection part and configured to suck out the processing dust remaining in the dust collection part to outside.

The invention according to claim 2 is to further solve the above problem by, in addition to the configuration of the invention according to claim 1, a feature in which the suction port part of the dust collector is disposed to face the slit-shaped gap region provided in the cylindrical body and is open in a circular arc manner, and the dust collection part of the dust collector is successively disposed in a circular arc manner to face an outer circumference side of the suction port part.

The invention according to claim 3 is to further solve the above problem by, in addition to the configuration of the invention according to claim 1 or claim 2, a feature in which the dust collection part of the dust collector has a narrowed portion connected to the suction port part and formed in such a manner as to have an opening width narrower than an opening width of the suction port part.

The invention according to claim 4 is to further solve the above problem by, in addition to the configuration of the invention according to claim 1 or claim 2, a feature in which the narrowed portion of the dust collection part is configured to be narrowed gradually from an inner circumference side toward an outer circumference side of the dust collection part.

The invention according to claim 5 is to further solve the above problem by, in addition to the configuration of the invention according to claim 1 or claim 2, a feature in which the cylindrical body further includes a suction air pump configured to create a negative pressure inside the cylindrical body.

The invention according to claim 6 is to further solve the above problem by, in addition to the configuration of the invention according to claim 1 or claim 2, a feature in which the dust collector is provided on a positioning rail which enables the dust collector to approach the gap region of the cylindrical body.

The invention according to claim 7 is to further solve the above problem by, in addition to the configuration of the invention according to claim 1 or claim 2, a feature in which the slit-shaped gap region provided in the cylindrical body is open in a direction perpendicular to a central axis of the cylindrical body.

### Effects of Invention

The laser processing apparatus according to the invention according to claim 1 comprises: a laser processing apparatus main body configured to radiate pulsed laser light from inside of a cylindrical body through a slit-shaped gap region provided in the cylindrical body onto a long, thin film, while the thin film is wound obliquely around the cylindrical body provided with the gap region having a shape of a circular arc along a circumferential surface and is transferred in a longitudinal direction of the thin film, and continuously create numerous through holes in the thin film; and a dust collector provided adjacent to the cylindrical body of the laser processing apparatus main body and configured to suck in and remove processing dust generated from laser processing, which can not only suck in and remove processing dust generated from laser processing, but also the following configurations specific to the present invention can provide effects specific to the present invention.

In other words, the dust collector includes a suction port part disposed to face the gap region of the cylindrical body, a dust collection part arranged successively with respect to the suction port part and configured to collect the processing dust, and a dust collection air pump connected to an outer circumference side of the dust collection part, so that the processing dust generated from laser processing is sucked without leaking by means of a suction force of the dust collection air pump through the suction port part into the dust collection part without diffusing in an outer circumference region of the cylindrical body, and the processing dust sucked into this dust collection part is continuously sucked out to outside without accumulating in the dust collection part, thereby ensuring a sufficient dust collection timing, reliably preventing clogging of the through holes in the thin film and dirt on the thin film likely to occur due to adhesion of the processing dust on the thin film during laser processing, creating the numerous fine through holes in the thin film with a high precision and at a high speed, and being capable of improving the precision and quality of various devices and products, etc. using such a thin film as subjected to this laser processing.

In the laser processing apparatus according to the invention according to claim 2, in addition to the effects produced by the invention according to claim 1, the suction port part of the dust collector is disposed to face the slit-shaped gap region provided in the cylindrical body and is open in a circular arc manner, and the dust collection part of the dust collector is successively disposed in a circular arc manner to face an outer circumference side of the suction port part, so that the suction port part of the dust collector sucks in without leaking the processing dust generated from the numerous through holes created in the thin film wound diagonally around the cylindrical body in a circular arc manner, and the dust collection part reliably collects the processing dust sucked in from this suction port part, whereby the processing dust generated from laser processing can be removed without remaining on the thin film.

In the laser processing apparatus according to the invention according to claim 3, in addition to the effects produced by the invention according to claim 1 or claim 2, the dust collection part of the dust collector has a narrowed portion connected to the suction port part and formed in such a manner as to have an opening width narrower than an opening width of the suction port part, so that an air flow rate at the narrowed portion of the dust collection part is increased compared to that at the suction port part, and accordingly a suction force and suction efficiency of the dust collection air pump necessary for suction and removal of the processing dust can be improved.

In the laser processing apparatus according to the invention according to claim 4, in addition to the effects produced by the invention according to claim 3, the narrowed portion of the dust collection part is configured to be narrowed gradually from an inner circumference side toward an outer circumference side of the dust collection part, thereby suppressing vortices and turbulent flows toward the outer circumference side of the dust collection part during suction and collection by the dust collection air pump, smoothly converging an air flow inside the dust collection part, and restraining unnecessary adhesion and accumulation of the processing dust on the inner wall surfaces of the suction port part and the dust collection part, so that maintenance, such as periodic cleaning of the inner wall surfaces of the suction port part and the dust collection part of the dust collector, can be carried out simply and easily.

In the laser processing apparatus according to the invention according to claim 5, in addition to the effects produced by the invention according to claim 1 or claim 2, the cylindrical body includes a suction air pump configured to create a negative pressure inside the cylindrical body so as to prevent an outer circumference portion of the through holes from lifting up likely to occur in the thin film due to a suction force of the dust collector during laser processing, so that an accuracy of a perforation shape by laser processing can be significantly improved.

In the laser processing apparatus according to the invention according to claim 6, in addition to the effects produced by the invention according to claim 1 or claim 2, the dust collector is provided on a positioning rail which enables the dust collector to approach the gap region of the cylindrical body, so that the positioning rail allows the dust collector to approach accurately when the dust collector is disposed to face the gap region of the cylindrical body in order to carry out laser processing, and the positioning rail makes it easier for the dust collector to retreat from the gap region of the cylindrical body in order to carry out maintenance on the laser processing apparatus, and thus the laser processing apparatus can be handled simply and easily.

In the laser processing apparatus according to the invention according to claim 7, in addition to the effects produced by the invention according to claim 1 or claim 2, the slit-shaped gap region provided in the cylindrical body is open in a direction perpendicular to a central axis of the cylindrical body, so that similar to the gap region of the cylindrical body, the suction port part of the dust collector provided opposite and along the gap region of the cylindrical body is also arranged diagonally with respect to a transfer direction of the thin film, and consequently the suction port part of the dust collector collects dust while scanning the thin film provided with numerous through holes after laser processing, and thus a more sufficient dust collection timing can be ensured compared to a configuration in which the suction port part of the dust collector is arranged perpendicularly to a transfer direction of the thin film.

### BRIEF DESCRIPTION OF DRAWINGS

FIG. 1 a schematic diagram of a laser processing apparatus according to an embodiment of the present invention.

FIG. 2 an exploded assembly diagram of a cylindrical body used in the laser processing apparatus as illustrated in FIG. 1.

FIG. 3 a diagram of a mechanism for generating pulsed laser light used in the laser processing apparatus as illustrated in FIG. 1.

FIG. 4 a diagram illustrating an arrangement of a dust collector in the laser processing apparatus as illustrated in FIG. 1.

FIG. 5 a schematic diagram of the dust collector used in the laser processing apparatus as illustrated in FIG. 1.

FIG. 6 a diagram illustrating a flow of processing dust relative to pulsed laser light during laser processing.

FIG. 7 a diagram illustrating a perforation state and a flow of the processing dust in laser processing. FIG. 8 a diagram illustrating a transfer direction of a thin film in laser processing and a configuration of the dust collector.

### DESCRIPTION OF EMBODIMENTS

Any specific embodiment of the present invention may be suitable as long as a laser processing apparatus comprising: a laser processing apparatus main body configured to radiate pulsed laser light from inside of a cylindrical body through a slit-shaped gap region provided in the cylindrical body onto a long, thin film, while the thin film is wound obliquely around the cylindrical body provided with the gap region having a shape of a circular arc along a circumferential surface and is transferred in a longitudinal direction of the thin film, and continuously create numerous through holes in the thin film; and a dust collector provided adjacent to the cylindrical body of the laser processing apparatus main body and configured to suck in and remove processing dust generated from laser processing, in which the dust collector includes a suction port part disposed to face the gap region of the cylindrical body and configured to suck in the processing dust, a dust collection part arranged successively with respect to the suction port part and configured to collect the processing dust sucked in from the suction port part, and a dust collection air pump connected to an outer circumference side of the dust collection part and configured to suck out the processing dust remaining in the dust collection part to outside, which reliably prevents clogging of through holes in a thin film and dirt on the thin film likely to occur due to adhesion of processing dust on the thin film during laser processing and creates numerous fine through holes in the thin film with a high precision and at a high speed.

In other words, the cylindrical body of the laser processing apparatus main body which constitutes a part of the laser processing apparatus according to the present invention typically has such a cylindrical outer shape that is interposed between a supply reel configured to transfer a long, thin film and a take-up reel configured to transport out the thin film and allows the thin film to be wound diagonally around a circumferential surface for about half the circumference, but as long as the outer shape allows the thin film to be wound diagonally around the circumferential surface which is the entire circumference or a part of the circumference of the cylindrical body, there may be employed a cylindrical outer shape, for example, constituted by a part of the circumferential surface having a semi-circular cross section and the other circumferential surface having a non-circular cross section.

Here, it is needless to say to provide inside the cylindrical body an installation space in which various components for emitting the pulsed laser light can be placed.

The cylindrical body of the laser processing apparatus main body as described above is preferably configured by joining together cylindrical left and right drums having the same diameter, but for example, the entirety of the cylindrical body may also be integrally configured and provided with a gap region, an attachment part for various components, a working space, a path for the pulsed laser light, a window for working, etc. for a corresponding portion, as necessary, such that the pulsed laser light can be introduced from outside into the cylindrical body and then emitted from the gap region.

Further, to configure the cylindrical body of the laser processing apparatus main body, it is preferable in view of handling of the laser processing apparatus to configure the cylindrical body by joining together cylindrical left and right drums having the same diameter and provide a gap region to a circumferential surface at a longitudinal center part of the cylindrical body which constitutes the joint part, but the cylindrical body may be integrally configured without joining together the left and right drums.

Then, regarding a specific arrangement of this gap region, since the gap region is a passage for the pulsed laser light emitted from inside the cylindrical body toward outside and is also a site at which processing of the thin film is carried out, it is preferable that a shape of the gap region is a thin slit along the circumferential surface.

Further, it is needless to say that it is preferable that the longer the length along the arc in the gap region of the cylindrical body is, the longer the distance for one scan by the pulsed laser light is and accordingly the more efficiently the laser processing is carried out.

No matter what shape the entire cylindrical body of the laser processing apparatus main body is configured to have, it is preferable that the circumferential surface with which the thin film comes into contact has low friction and excellent wear resistance, and thus it is desirable to carry out a surface treatment, such as coating with various fluororesins.

For the fluororesin in this case, at least one of PTFE (polytetrafluoroethylene), PFA (tetrafluoroethylene-perfluoroalkyl vinyl ether copolymer), FEP (tetrafluoroethylene-hexafluoropropylene copolymer), ETFE (tetrafluoroethylene-ethylene copolymer), PVDF (polyvinylidene fluoride), PCTFE (polychlorotrifluoroethylene), and ECTFE (chlorotrifluoroethylene-ethylene copolymer) may be used.

A thin film transfer means of the laser processing apparatus main body constituting a part of the present invention may be specifically configured in any way as long as the thin film transfer means includes a supply reel for transferring a flexible, long, thin film and a take-up reel for taking up the long thin film, a transfer shaft constituting this thin film transfer means is arranged diagonally with respect to the central axis extending in a longitudinal direction of the cylindrical body, and the thin film is wound diagonally around the cylindrical body and thus transferred.

For a motor of the laser processing apparatus main body constituting a part of the present invention, any of various motors usually used for rotating an optical system may be used, and more specifically, various AC motors, DC motors, stepping motors, servo motors, brushless motors, and gear motors may be used, but it is preferable that a rotation axis of the motor is fixed inside the cylindrical body in such a manner as to coincide with the central axis and a rotation direction of the motor corresponds to a direction along which the thin film is transferred.

For a reflecting member of the laser processing apparatus main body constituting a part of the present invention, any optical element which is arranged in a path of the pulsed laser light and capable of changing a traveling direction of the pulsed laser light at a right angle may be used, and more specifically, it is more preferable to use various reflecting mirrors or right-angle prisms.

Further, it is preferable to fix this reflecting member to an optical base and then attach the optical base to the rotation shaft of the motor so that the reflecting member is rotatably arranged inside the cylindrical body.

For a focusing means of the laser processing apparatus main body constituting a part of the present invention, various optical lenses may be used, and specifically, either a spherical lens or an aspherical lens may be used.

For a laser emission means of the laser processing apparatus main body which constitutes a part of the present invention, various industrial laser emission devices may be used, and specifically, it is preferable to use KrF, ArF, XeCl, XeF excimer lasers, Nd-YAG laser, CO2 laser, CO laser, nitrogen laser, solid-state laser, ruby laser, semiconductor laser, tunable diode laser, etc.

Here, it is needless to say that the intensity (height) and duration (width) of the pulsed laser light emitted from the laser emission means are set depending upon physical properties of the thin film such that creation of a through hole is achieved by means of a single pulsed radiation.

In addition, a pulse period of the pulsed laser light emitted from the laser emission means can be set to 100 KHz or more and 112 KHz or less, and a pulse width thereof can be set to 1 nanosecond or more and 100 nanoseconds or less, but this setting is not restrictive since in general the smaller the pulse width is, the less likely it is that the thin film is thermally affected, which is preferable.

Further, in the laser processing apparatus according to the present invention, it is more preferable to place various beam expanders on a path of the pulsed laser light to reduce a beam spot diameter when the pulsed laser light is focused on the thin film to be processed, thereby carrying out fine laser processing with a higher power density and less thermal effects.

Next, for the dust collector used in the laser processing apparatus, any specific embodiment thereof may be suitable as long as the dust collector is disposed to face the gap region of the laser processing apparatus main body in such a manner as to be capable of approaching the same and configured to suck in and remove processing dust generated from laser processing, in which the dust collector includes a suction port part disposed to face the slit-shaped gap region provided in the cylindrical body, a dust collection part arranged successively with respect to this suction port part, and a dust collection air pump connected to an outer circumference side of this dust collection part.

In other words, for a specific embodiment of the suction port part and the dust collection part in the dust collector, to suck in without leaking the processing dust generated from the numerous through holes created in the thin film and reliably collect by means of the dust collection part the processing dust sucked in from this suction port part, it is preferable that the suction port part is open in a circular arc manner so as to closely face the slit-shaped gap region provided in the cylindrical body, and the dust collection part is successively disposed in a circular arc manner to face an outer circumference side of the suction port part.

To increase an air flow rate at the narrowed portion of the dust collection part compared to that at the suction port part and improve a suction force at the suction port part, it is more preferable to provide the dust collection part with a narrowed portion having an opening width narrower than an opening width of the suction port part.

Further, for this narrowed portion of the dust collection part, it is even more preferable that to suppress vortices and turbulent flows toward the outer circumference side of the dust collection part during suction and collection by the dust collection air pump, smoothly converge an air flow inside the dust collection part, and restrain unnecessary adhesion and accumulation of the processing dust on the inner wall surfaces of the suction port part and the dust collection part, the narrowed portion of the dust collection part is configured to be narrowed gradually from an inner circumference side toward an outer circumference side of the dust collection part.

Moreover, to prevent an outer circumference portion of the through holes from lifting up likely to occur in the thin film due to a suction force of a dust collector during laser processing, a suction air pump configured to create a negative pressure inside the cylindrical body may be provided in the cylindrical body.

For the dust collector used in the laser processing apparatus according to the present invention, to restrain unnecessary adhesion and accumulation of the processing dust on the inner wall surface of the dust collection part, it is desirable to carry out a surface treatment, such as coating with various fluororesins.

In addition, to handle the laser processing apparatus main body and the dust collector in the laser processing apparatus simply and easily, the dust collector as described above is provided on a positioning rail which enables the dust collector to approach the gap region of the cylindrical body, which allows the dust collector to relatively move along the positioning rail and approach accurately when the dust collector is disposed to face the gap region of the cylindrical body in order to carry out laser processing, and relatively moves the dust collector along the positioning rail in such a manner as to make it easier for the dust collector to retreat from the gap region of the cylindrical body in order to carry out maintenance on the laser processing apparatus.

An object to be processed in the laser processing apparatus according to the present invention may be a thin metal film, a resin sheet, or a flexible metal oxide-containing thin film or other composite material as a composite material, as long as the object to be processed is a flexible, long thin film.

For example, examples of metal materials may include copper, aluminum, nickel, and various stainless steels, while examples of resin materials may include various conductive plastics such as polythiophene-based, polyacetylene-based, polyaniline-based, and polypyril-based plastics, engineering plastics, such as PPSU, PSU, PAR, PEI, PEEK, PPS, PES, PAI, LCP, PTFE, PCTFE, PVDF, PC, m-PPE, PA6, PA66, POM, PET, PBT, and U-PE, and general-purpose plastics, such as PVC, PS, ABS, AS, PMMA, PE, and PP.

Further, the processed object provided with numerous through holes by the laser processing apparatus according to the present invention is used particularly as an electrode for lithium ion batteries, all-solid-state batteries, semi-solid batteries, etc., but it is needless to say that the processed object can be used for those other than these electrodes.

### EMBODIMENTS

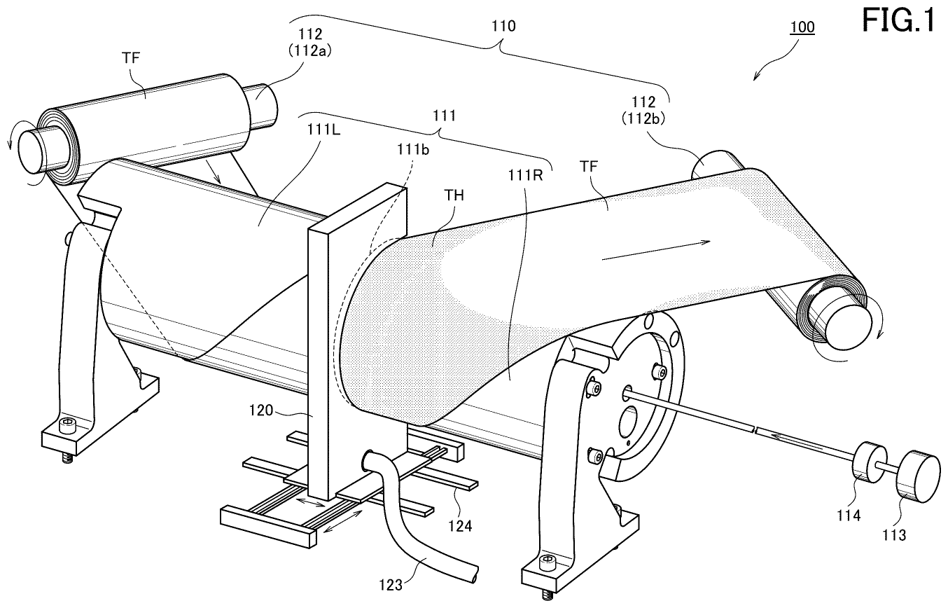

Hereinafter, a laser processing apparatus according to an embodiment of the present invention will be described with reference to FIG. 1 to FIG. 8.

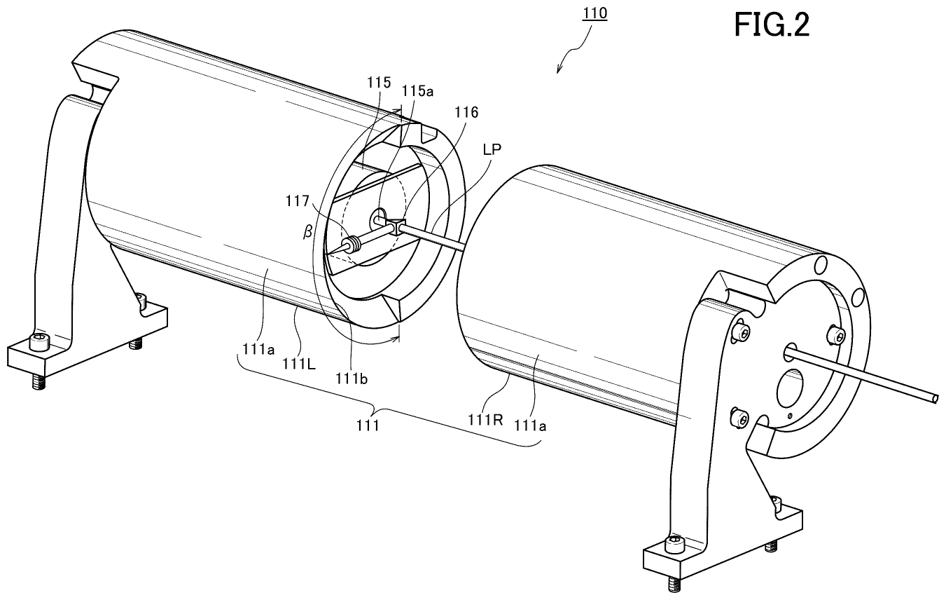

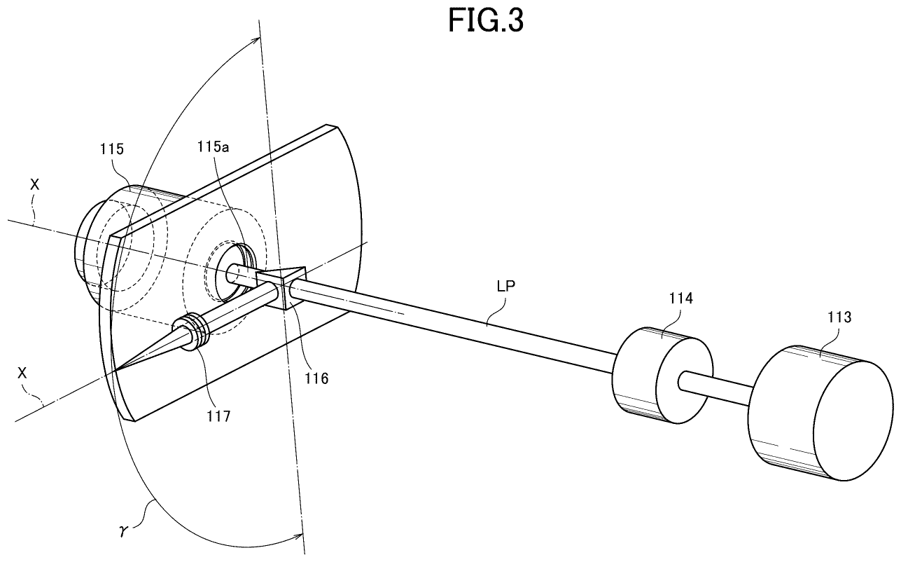

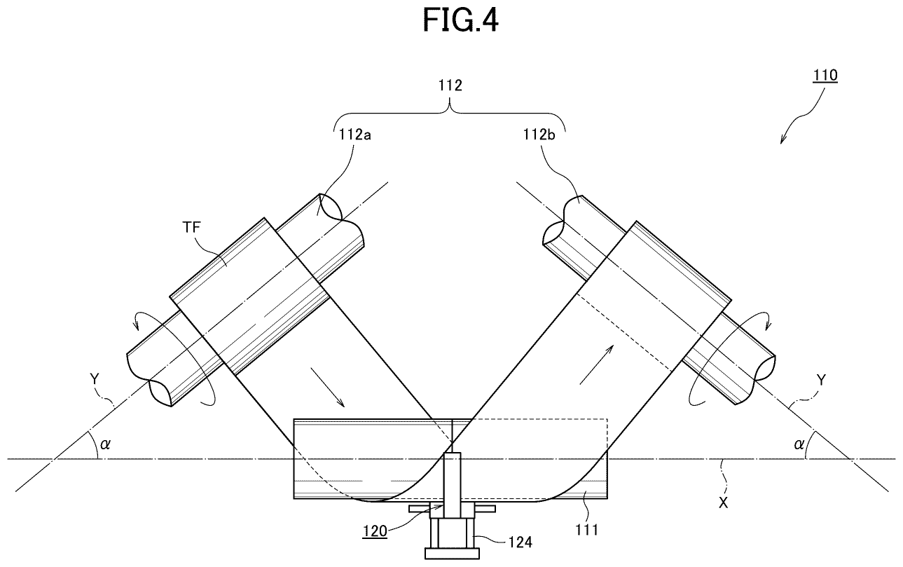

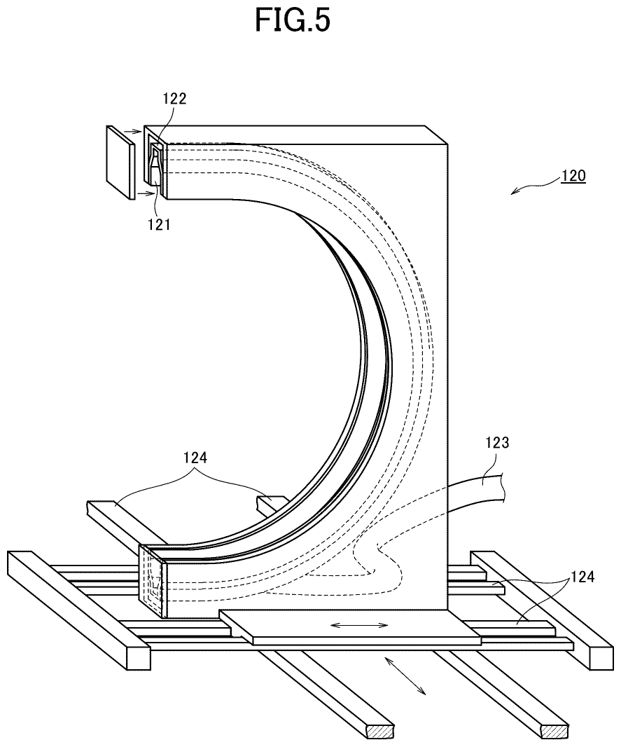

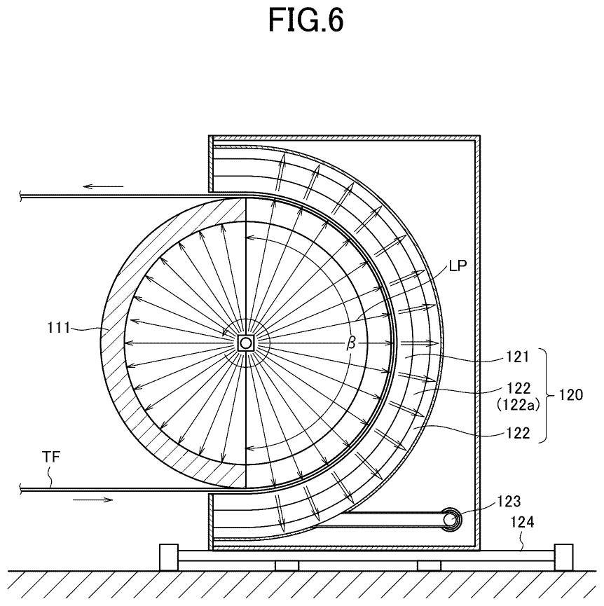

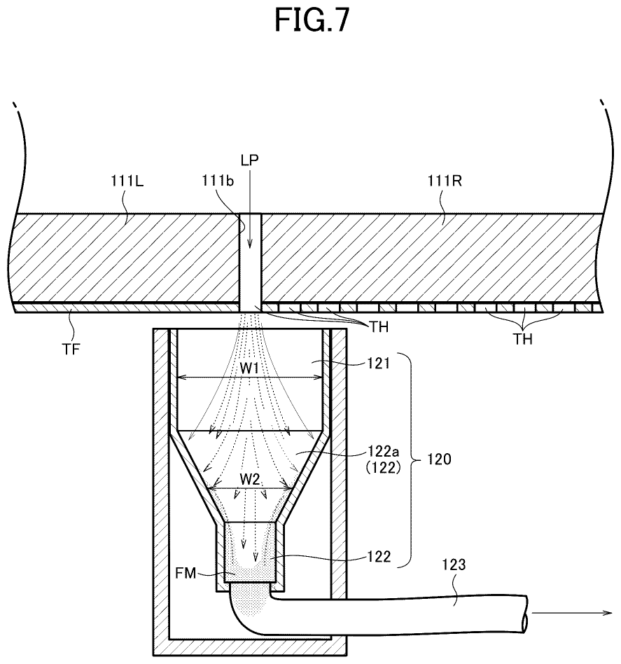

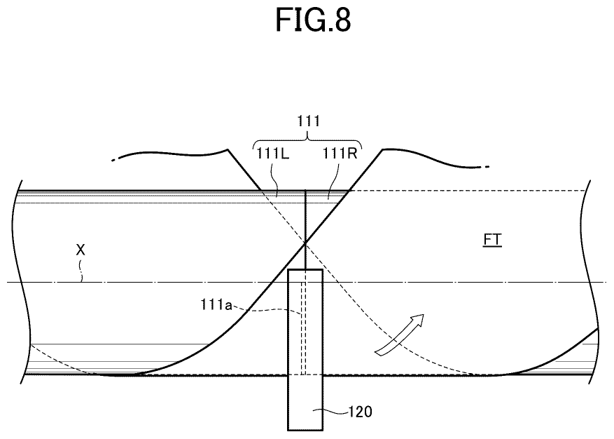

Here, FIG. 1 is a schematic diagram of a laser processing apparatus according to an embodiment of the present invention, FIG. 2 is an exploded assembly diagram of a cylindrical body used in the laser processing apparatus illustrated in FIG. 1, FIG. 3 is a diagram of a mechanism for generating pulsed laser light used in the laser processing apparatus illustrated in FIG. 1, FIG. 4 is a diagram illustrating an arrangement of a dust collector in the laser processing apparatus illustrated in FIG. 1, FIG. 5 is a schematic diagram of the dust collector used in the laser processing apparatus illustrated in FIG. 1, FIG. 6 is a diagram illustrating a flow of processing dust relative to pulsed laser light during laser processing, FIG. 7 is a diagram illustrating a perforation state and a flow of the processing dust in laser processing, and FIG. 8 is a diagram illustrating a transfer direction of a thin film in laser processing and a configuration of the dust collector.

As illustrated in FIG. 1, a laser processing apparatus 100 according to an embodiment of the present invention is provided with a laser processing apparatus main body 110 configured to continuously create numerous through holes TH in a matrix shape in a long, thin film TF which is an object to be processed, and a dust collector 120 provided adjacent to a cylindrical body 111 of the laser processing apparatus main body 110 and configured to suck in and remove processing dust FM generated from laser processing.

In other words, the laser processing apparatus 100 according to the present embodiment is configured to process the long, thin film TF made of a metal, for example, copper, and includes: a laser processing apparatus main body 110 configured to radiate pulsed laser light LP from inside of a cylindrical body 111 through a slit-shaped gap region of the cylindrical body 111 onto a long, thin film TF, while the thin film TF is wound obliquely around the cylindrical body 111 provided with the gap region 111b having a shape of a semi-circular arc along a circumferential surface 111a and is transferred in a longitudinal direction of the thin film TF, and continuously create numerous through holes TH in this thin film TF; and a dust collector 120 provided adjacent to the cylindrical body 111 of this laser processing apparatus main body 110 and configured to suck in and remove processing dust FM generated from laser processing.

### Specific Configuration of the Laser Processing Apparatus Main Body 110

Then, a specific configuration of the laser processing apparatus main body 110 will be described below based on FIG. 1 to FIG. 4.

First, as illustrated in FIG. 1 and FIG. 4, the laser processing apparatus main body 110 used in the laser processing apparatus 100 according to the present embodiment is configured so that a thin film transfer means 112 is arranged such that the thin film TF wound around a supply reel 112a is pulled out and wound obliquely around the cylindrical body 111, and then taken up by a take-up reel 112b at a constant transfer speed in a longitudinal direction.

Here, as illustrated in FIG. 4, central axes Y of the supply reel 112a and the take-up reel 112b in the present embodiment are positioned at the same deviation angle α with respect to a central axis X of the cylindrical body 111, thereby stabilizing pulling out and taking up of the thin film TF.

As illustrated in FIG. 2, in the cylindrical body 111, a circumferential surface 111a around which the copper thin film TF is wound has a cylindrical outer surface shape, so that the thin film TF in intimate contact with the cylindrical body 111 has a cylindrical shape at least in a portion in contact with the cylindrical body 111.

In the present embodiment, a winding angle is set to approximately π (rad) so that the circumferential surface 111a for at least π (rad) is accordingly formed.

As illustrated in FIG. 2 the cylindrical body 111 in this embodiment is formed by joining together cylindrical left drum 111L and right drum 111R having the same diameter.

Consequently, the cylindrical body 111 as a whole has an appearance of a long, hollow cylinder.

As illustrated in FIG. 1 and FIG. 2, on the front side of a portion at which the left drum 111L and the right drum 111R are joined together, the left drum 111L which constitutes the cylindrical body 111 has such a shape that a gap region 111b is formed at a portion joined to the right drum 111R.

As illustrated in FIG. 4, the long, slit-shaped gap region 111b is formed along a circumferential direction, and the thin film TF is wound around the cylindrical body 111 in such a manner as to cover the gap region 111b.

Further, on the front side of the cylindrical body 111, this gap region 111b is formed in such a manner as to have a shape of a long, thin slit in the circumferential direction, and an opening angle β of the gap region 111b with respect to the central axis X of the cylindrical body 111 is configured to be approximately II (rad).

Then, as illustrated in FIG. 1 and FIG. 2, in the cylindrical body 111 used in the present embodiment, an entrance window for the pulsed laser light LP is formed in the center of a right end face of the right drum 111R so that the pulsed laser light LP emitted from the laser light emission means 113 is incident on the cylindrical body 111 such that an optical axis of this pulsed laser light LP is coaxial with the central axis X of the cylindrical body 111.

Then, the pulsed laser light LP emitted from the laser light emission means 113 passes through the beam expander 114, thereby expanding the beam diameter, so that the pulsed laser light LP enters the cylindrical member 111 through the entrance window of the cylindrical member 111.

Note that the laser light emission means 113 and the beam expander 114 are arranged such that corresponding optical axes are coaxial with the central axis X of the cylindrical member 111.

On the other hand, as illustrated in FIG. 2 and FIG. 3, a motor 115 is fixed to the left drum 111L which constitutes the cylindrical body 111, and a rotation axis M of this motor 115 is positioned coaxial with the central axis X of the cylindrical body 111.

A rotation axis shaft 115a of this motor 115 is provided with a reflecting member 116 for reflecting the pulsed laser light LP incident through the entrance window of the cylindrical body 111 toward the gap region 111b of the cylindrical body 111, and the reflecting member 116 is rotatably connected thereto.

Thus, as illustrated in FIG. 2 and FIG. 3, depending upon the rotation of this reflecting member 116, an emission direction Z of the pulsed laser light LP changes after reflection by the reflecting member 116 within a plane perpendicular to the central axis X of the cylindrical body 111, such that the pulsed laser light LP is emitted from the gap region 111b of the cylindrical body 111 within a range of an radiation angle γ of the pulsed laser light LP with reference to the rotation axis M of the motor 115.

In other words, the pulsed laser light LP incident on the reflecting member 116 is reflected by the reflecting member 116, which changes a traveling direction at a right angle, then accordingly travels in a radial direction of the cylindrical body 111, and is emitted from the slit-shaped gap region 111b to the outside of the cylindrical body 111.

Then, as illustrated in FIG. 2 and FIG. 3, between the reflecting member 116 and the thin film TF, a focusing means 117 is disposed to focus the pulsed laser light LP after reflection by the reflecting member 116 onto the circumferential surface 111a of the cylindrical body 111, i.e., onto the thin film TF.

The pulsed laser light LP emitted from this gap region 111b is radiated onto the thin film TF having a shape cylindrical along the cylindrical body 111.

Note that depending upon the orientation of the reflecting member 116, a direction in which the pulsed laser light LP is emitted may deviate from the range of the radiation angle γ of the pulsed laser light LP with respect to the rotation axis M, and therefore an emission timing of the laser light emission means 113 is controlled such that the pulsed laser light LP is not emitted in such a timing.

The laser processing apparatus main body 110 used in the laser processing apparatus 100 according to the present embodiment has such an apparatus configuration as described above, and thus to form the through holes TH in a copper thin film TF which is the long metal thin film TF, the focusing means 117 and the like are adjusted such that the pulsed laser light LP is focused at a desired position on the thin film TF before the motor 115 is rotated to rotate a right-angle prism serving as the reflecting member 116, then the copper thin film TF wound around the supply reel 112a is pulled out and wound obliquely around the cylindrical body 111 and in such a manner as to cover the gap region 111b and is further wound around the take-up reel 112b, and the supply reel 112a and the take-up reel 112b are rotated while a rotation period thereof is controlled such that a feed speed is, for example, 1 m/min.

Then, the pulsed laser light LP having, for example, an emission period of 111 kHz and a pulse width of 10 nsec is emitted from the laser light emission means 113 such that a single pulse radiation creates numerous through holes TH in the thin film TF, and passes through the beam expander 114 to be incident from the entrance window on the right end face of the cylindrical body 111 so as to irradiate the reflecting member 116.

Then, the laser light emission means 113 is controlled in synchronization with the rotation of the motor 115, and an emission pause period is set such that the pulsed laser light LP is emitted only at a timing when passing through the gap region 111b after being reflected by the reflecting member 116.

Further, the cylindrical body 111 is provided with a suction air pump (unillustrated) configured to create a negative pressure inside this cylindrical body 111 so as to prevent an outer circumference portion of the through holes TH from lifting up likely to occur in the thin film TF due to a suction force of a dust collector 120 during laser processing.

Thus, by appropriately adjusting and controlling a rotation period of the motor 115, a feed speed of the thin film TF, and a setting of the pulsed laser light LP, for example, 1000 through holes TH at a pitch of 114 μm are continuously created in a diagonal row in the thin film TF during one rotation of the motor 115, and by repeatedly forming such a row of through holes TH in the same direction multiple times while transferring the thin film TF, a porous copper thin film TF having a formation pattern of the through holes TH arranged in a matrix shape with equal intervals is obtained.

### Regarding a Specific Configuration of the Dust collector 120

A specific configuration of the dust collector 120 used in the laser processing apparatus 100 according to the present embodiment will be described below with reference to FIG. 1 and FIG. 5 to FIG. 7.

First, as illustrated in FIG. 5 to FIG. 7, the dust collector 120 used in the laser processing apparatus 100 according to the present embodiment and configured to suck in and remove the processing dust FM generated from laser processing includes a suction port part 121 disposed to face the gap region 111b of the cylindrical body 111, a dust collection part 122 arranged successively with respect to this suction port part 121 and configured to collect the processing dust FM, and a dust collection air pump 123 connected to an outer circumference side of this dust collection part 122, and the dust collector 120 is configured such that the processing dust FM generated from laser processing is sucked without leaking by means of a suction force of the dust collection air pump 123 through the suction port part 121 into the dust collection part 122 without diffusing in an outer circumference region of the cylindrical body 111, and the processing dust FM sucked into this dust collection part 122 is continuously sucked out to outside without accumulating in the dust collection part 122.

Note that an inner wall surface of this dust collection part 122 is subjected to a surface treatment, such as coating with various fluororesins, to prevent unnecessary adhesion and accumulation of the processing dust FM on the inner wall surface of the dust collection part 122.

In more detail, as illustrated in FIG. 1 and FIG. 5, it is configured such that the suction port part 121 of the dust collector 120 is disposed to face the gap region 111b of the cylindrical body 111 and is open in a semi-circular arc manner, and the dust collection part 122 of the dust collector 120 is successively disposed in a semi-circular arc manner to face an outer circumference side of the suction port part 121, and as illustrated in FIG. 7, the suction port part 121 of the dust collector 120 sucks in without leaking the processing dust FM generated from the numerous through holes TH created in the thin film TF wound diagonally around the cylindrical body 111 in a semi-circular arc manner, and the dust collection part 122 reliably collects the processing dust FM sucked in from this suction port part 121.

Thus, as illustrated in FIG. 8, the slit-shaped gap region 111b provided in the cylindrical body 111 is open in a direction perpendicular to the central axis X of the cylindrical body 111, and, similar to the gap region 111b of the cylindrical body 111, the suction port part 121 of the dust collector 120 provided opposite and along the gap region 111b of the cylindrical body 111 is also arranged diagonally with respect to a transfer direction of the thin film TF, so that the suction port part 121 of the dust collector 120 collects dust while scanning the thin film TF provided with numerous through holes TH after laser processing.

Then, as illustrated in FIG. 7, the dust collection part 122 of the dust collector 120 has a narrowed portion 122a connected to the suction port part 121 and formed in such a manner as to have an opening width W2 narrower than an opening width W1 of the suction port part 121, whereby an air flow rate at the narrowed portion 122a of the dust collection part 122 is increased compared to that at the suction port part 121, which thus increases a suction force at the suction port part 121.

Further, the narrowed portion 122a of the dust collection part 122 is configured to be narrowed gradually from an inner circumference side toward an outer circumference side of this dust collection part 122, thereby suppressing vortices and turbulent flows toward the outer circumference side of the dust collection part 122 during suction and collection by the dust collection air pump 123, smoothly converging an air flow inside the dust collection part 122, and restraining unnecessary adhesion and accumulation of the processing dust FM on the inner wall surfaces of the suction port part 121 and the dust collection part 122.

Further, as illustrated in FIG. 1 and FIG. 5, the dust collector 120 is slidably provided on a positioning rail 124, such as a slide rail, which enables the dust collector 120 to approach the gap region 111b of the cylindrical body 111, the positioning rail 124 allows the dust collector 120 to approach accurately when the dust collector 120 is disposed to face the gap region 111b of the cylindrical body 111 in order to carry out laser processing, and the positioning rail 124 can relatively move the dust collector 120 in such a manner as to make it easier for the dust collector 120 to retreat from the gap region 111b of the cylindrical body 111 in order to carry out maintenance on the laser processing apparatus 100.

As described above, the laser processing apparatus 100 according to the present embodiment can continuously create in the thin film TF the numerous fine through holes TH uniform in shape and arrangement in which generation of burrs is suppressed, and can carry out high-precision laser processing in which working efficiency of processing is significantly improved.

In addition, it is possible to carry out high-precision laser processing which can continuously create in the thin film TF the numerous fine through holes TH uniform in shape and arrangement in which generation of burrs is suppressed and can significantly improve working efficiency of processing, as well as low-cost laser processing with reduced wear on the laser processing apparatus 100.

Further, regarding the dust collector 120 used in the laser processing apparatus 100 according to the present embodiment, similar to the gap region 111b of the cylindrical body 111, the dust collector 120 is disposed diagonally with respect to a transfer direction of the thin film TF so as to ensure a sufficient dust collection timing, reliably prevent clogging of the through holes TH in the thin film TF and dirt on the thin film TF likely to occur due to adhesion of the processing dust FM on the thin film TF during laser processing, and create the numerous fine through holes TH in the thin film TF with a high precision and at a high speed, and the precision and quality of various devices and products, etc. using such a thin film TF as subjected to this laser processing can be not only improved, but also the processing dust FM generated from laser processing can be removed without remaining on the thin film TF, and a suction force and suction efficiency of the dust collection air pump 123 necessary for suction and removal of the processing dust FM can be improved.

Further, such effects produced are considerable since maintenance, such as periodic cleaning of the inner wall surfaces of the suction port part 121 and the dust collection part 122 of the dust collector 120, is simple and easy.

### REFERENCE SIGNS LIST

100 laser processing apparatus
110 laser processing apparatus main body
111 cylindrical body
111a circumferential surface of cylindrical body 111
111b gap region
111L left drum
111R right drum
112 thin film transfer means
112a supply reel
112b take-up reel
113 laser light emission means
114 beam expander
115 motor
115a rotation axis shaft
116 reflecting member
117 focusing means
120 dust collector
121 suction port part
122 dust collection part
122a narrowed portion of dust collection part 122
123 dust collection air pump
124 positioning rail
TF thin film
TH through hole
FM processing dust
X central axis of cylindrical body 111
Y central axes of supply reel and take-up reel
Z emission direction of pulsed laser light LP
LP pulsed laser light
M rotation axis of motor 115
α deviation angle of supply reel and take-up reel with respect to central axis of cylindrical body 111
β opening angle of gap region 111b
γ radiation angle of pulsed laser light LP
W1 opening width of suction port part 121
W2 opening width of narrowed portion 122a provided in dust collection part 122

1. A laser processing apparatus comprising: a laser processing apparatus main body configured to radiate pulsed laser light from inside of a cylindrical body through a slit-shaped gap region provided in the cylindrical body onto a long, thin film, while the thin film is wound obliquely around the cylindrical body provided with the gap region having a shape of a circular arc along a circumferential surface and is transferred in a longitudinal direction of the thin film, and continuously create numerous through holes in the thin film; and a dust collector provided adjacent to the cylindrical body of the laser processing apparatus main body and configured to suck in and remove processing dust generated from laser processing, characterized in that
the dust collector includes a suction port part disposed to face the gap region of the cylindrical body and configured to suck in the processing dust, a dust collection part arranged successively with respect to the suction port part and configured to collect the processing dust sucked in from the suction port part, and a dust collection air pump connected to an outer circumference side of the dust collection part and configured to suck out the processing dust remaining in the dust collection part to outside.

2. The laser processing apparatus according to claim 1, characterized in that the suction port part of the dust collector is disposed to face the slit-shaped gap region provided in the cylindrical body and is open in a circular arc manner, and
the dust collection part of the dust collector is successively disposed in a circular arc manner to face an outer circumference side of the suction port part.

3. The laser processing apparatus according to claim 2, characterized in that the dust collection part of the dust collector has a narrowed portion connected to the suction port part and formed in such a manner as to have an opening width narrower than an opening width of the suction port part.

4. The laser processing apparatus according to claim 3, characterized in that the narrowed portion of the dust collection part is configured to be narrowed gradually from an inner circumference side toward an outer circumference side of the dust collection part.

5. The laser processing apparatus according to claim 2, characterized in that the cylindrical body further includes a suction air pump configured to create a negative pressure inside the cylindrical body.

6. The laser processing apparatus according to claim 2, characterized in that the dust collector is provided on a positioning rail which enables the dust collector to approach the gap region of the cylindrical body.

7. The laser processing apparatus according to claim 2, characterized in that the slit-shaped gap region provided in the cylindrical body is open in a direction perpendicular to a central axis of the cylindrical body.
